(19) United States
(12) Patent Application Publication
(10) Pub. No.: US 2026/0226947 A1
(43) Pub. Date: Aug. 6, 2026

(54) STEERING MECHANISM OF POWER WINCH CLUTCH LEVER

(71) Applicant: COMEUP INDUSTRIES INC., NEW TAIPEI CITY (TW)

(72) Inventor: Kuo-Hsin Huang, NEW TAIPEI CITY (TW)

(21) Appl. No.: 19/045,898

(22) Filed: Feb. 5, 2025

(51) Int. Cl. F16D 23/12; B66D 1/22

(52) U.S. Cl. CPC F16D 23/12; B66D 1/22

(57) ABSTRACT

A steering mechanism of a power winch clutch lever is primarily to provide at least two positioning penetrating holes on the surface of the housing of the speed reducer of the power winch. One of the positioning penetrating holes is configured on the upper wall of the housing and the other positioning hole is configured on the front wall of the housing. The clutch lever of the power winch can be optionally inserted into either of the positioning penetrating holes to be positioned. As the clutch lever of the power winch can be conveniently inserted and positioned in either of the positioning holes, the power winch can have wider and diversified forms of installation and operation.

### BACKGROUND OF THE INVENTION

The present invention relates to a steering mechanism of power winch clutch lever, and more particularly to a steering mechanism of power winch clutch lever which allows adjustment or change of the configuration position of the clutch lever as desired, so that the power winch can have wider and diversified forms of installation and operation.

### DESCRIPTION OF THE RELATED ART

Accordingly, a power winch is a powered machine designed for hoisting or pulling heavy objects. Common examples are that the “lifting winch” used on high buildings for vertically lifting or lowering cargoes and another is the steel cable winch used on jeeps or SUVs for towing other vehicles (rescuing) or getting out of a dangerous site (escaping). As shown in FIG. 1, a prior-art power winch is provided with a power source 11 (such as a power motor) on one side to output a forward or backward direction driving power and a speed reducer 12 on the other side. A transmission shaft (not shown in the figure) is connected between the power source 11 and the speed reducer 12 for transmitting power, the power source 11 and the speed reducer 12 are connected and supported by a support frame 13, a cable wheel 14 is configured inside the internal space of the support frame 13, wherein the transmission shaft passes through the interior of the cable wheel 14, and therefore the power supplied by the power source 11 is transmitted by the transmission shaft to the speed reducer 12. After appropriate speed reduction, the power drives the cable wheel 14 to rotate (forward rotation or backward rotation) to release or withdraw the steel cable. On the front end of the steel cable, a heavy hook is provided for hooking a load (a heavy object, other vehicle, or other object), so that the load is moved.

The power winch is designed to use power for withdrawing or releasing the steel cable. Due to the necessary stage-by-stage speed reduction by the speed reducer 12, the releasing or withdrawing speed cannot be very fast. In case of emergency (such as rescuing vehicles or people in danger), the speed of releasing the steel cable by power cannot meet the requirement. Therefore, the prior-art power winch is configured with a clutch. What we can see outside the power winch is only a clutch lever 15, most of the components of the clutch are hidden inside the housing of the speed reducer 12. When the clutch lever 15 is operated to position the clutch at the “OPEN” status, the power transmission between the speed reducer 12 and the rope sheave 14 is disconnected (OPEN). Now, as the cable wheel 14 is free from power, the steel cable on the cable wheel 14 can be quickly pulled out and hung onto the vehicle or heave object to be lifted before it is too late. Then, when the clutch lever 15 is operated to return the clutch to the “CLOSED” status, the power of the speed reducer 12 is again transmitted to the cable wheel 14 (CLOSE), to use power to withdraw the steel cable and pull the heavy object.

The clutch of a power winch can have many different composition or operation forms. The applicant of the present invention has applied for the following Taiwan utility model patents: 186419, 188404, M291421, M344336, M449152, M540860 and M542645, and China Utility Model Patent: ZL01204721.X, ZL200520145068.5, ZL200820128343.6, 201220610649.1, USA No.: U.S. Pat. Nos. 7,648,125, 8,973,902, 10,189,686 and 10,138,099.

As shown in FIG. 1, the prior-art power winch comprises the shapes of the power source 11, the speed reducer 12 and the clutch lever 15 giving people a certain impression. In particular, the configuration of the clutch lever 15 on the housing of the speed reducer 12 is an unbreakable impression. It is generally believed that the clutch lever 15 configured above the housing of the speed reducer 12 can be accessed more easily so it is a best position to operate. Most of the conventional power winches are installed (fixed) on the front bottom of the vehicle. They are fixed above the front end of the chassis or on the front bumper. Later, users developed a new way of using the power winch. They install (fix) it on the bottom of the rear end of the vehicle. It is fixed above the rear end of the chassis or above the rear bumper. Some even install the power winch on an additional rack above the vehicle body. In all of the above installation forms, the clutch lever faces upward, so that the user can access and operate conveniently without any difficulty. However, in recent years, to be in line with the current trend of hiding, vehicle users tend to hide the devices installed outside the vehicle body. Therefore, a new form of using the power winch is developed. They install (fix) it under the front end of the vehicle body or under the rear end of the vehicle body. However, in this way, the clutch lever will have to face downward. In times of emergency, users find it difficult to operate the downward clutch lever. Moreover, the downward clutch lever may collide with other objects when the vehicle is travelling in a high speed. These are utilization deficiencies caused by the fixed (unchangeable) configuration position of the clutch lever.

To change the direction of the clutch lever 15 of the prior-art power winch, for example, to change the position of the clutch lever 15 from originally facing upward to facing forward, it is necessary to dismantle the outer housing of the speed reducer 12 and remove the speed reducing mechanism together with the braking mechanism installed inside it. Then, after changing the direction of the round housing together with the clutch lever 15, assemble them together again. As the dismantling and assembling operations involve complicated components and actions, it is not suitable for the user to do it by oneself. Such operations must be carried out by the manufacturer or the assembly plant based on the need of customers. In terms of time and operation needed for changing the position of the clutch lever, the prior-art power winch is inconvenient.

### SUMMARY OF THE INVENTION

In view of the above drawback, the present invention is further researched and improved. Therefore, it is a primary objective of the present invention to change the configuration position of the clutch lever and after making unremitting effort in improving the design, the inventor finally managed to develop the present invention.

The primary objective of the present invention is to provide a steering mechanism of power winch clutch lever allowing to adjust the configuration position of the clutch lever whenever needed.

To achieve the above-mentioned objective, the present invention is to provide a steering mechanism of power winch clutch lever, wherein the power winch comprises a support frame supporting a power source, a speed reducer and a cable wheel, the power source supplies power to transmit to the cable wheel via the speed reduction by the speed reducer, thereby enabling the cable wheel to rotate forward or backward; the speed reducer comprises a housing, a speed reducing mechanism and a clutch lever, wherein the housing is connected with the support frame, the surface of the housing is configured with the positioning hole, the speed reducing mechanism is composed of an internal gear ring and a planetary gear set, a plurality of positioning slots are configured on the outer wall of the internal gear ring, the internal gear ring is accommodated inside the housing, the planetary gear set is accommodated inside the internal gear ring and engaged with the internal gear ring for speed reduction, the clutch lever is inserted to the positioning hole on the housing, a pressing bar is configured inside the clutch lever, the pressing bar is controlled by the clutch lever to rise or fall, wherein the pressing bar falls to press into the positioning slot of the internal gear ring to allow the power of the speed reducer and the cable wheel to be transmitted and connected, and the pressing bar rises to withdrawn from the positioning slot of the internal gear ring to allow the power transmission between the speed reducer and the rope sheave to be interrupted, characterized in that: at least two positioning penetrating holes are configured on the surface of the housing, one is defined on the upper wall of the housing, the other one is defined on the front wall of the housing, the clutch lever can be alternatively inserted in the positioning hole on the upper wall of the housing or inserted in positioning hole on the front wall of the housing.

According to the above-mentioned steering mechanism of power winch clutch lever, the housing comprises a central housing and an outer housing, the central housing is connected with the support frame, and the outer housing is connected with the central housing, the positioning penetrating hole is configured on the surface of the central housing, a round space is configured inside the central housing on the side facing the support frame, the internal gear ring is housed inside the round space of the central housing.

According to the above-mentioned steering mechanism of power winch clutch lever, the longitudinal deep screw holes are respectively configured on a side where the central housing away from the support frame and corresponds to the two positioning penetrating holes, the screw holes are communicated to the corresponding positioning penetrating holes, the clutch lever comprises a pressing block and the pressing block can be pressed along the corresponding screw holes to tightly abut against the clutch lever.

According to the above-mentioned steering mechanism of power winch clutch lever, the positioning penetrating holes can be covered by a cover body.

According to the above-mentioned structure combination, the primary feature of the present invention is to provide at least two positioning penetrating holes on the surface of the housing of the speed reducer of the power winch, wherein one is defined on the upper wall of the housing and the other one is defined on the front wall of the housing, the clutch lever of the power winch can be alternatively inserted into either of the positioning penetrating holes to be positioned, and as the clutch lever of the power winch can be conveniently inserted and positioned in either of the positioning holes, the power winch can have wider and diversified forms of installation and operation.

### BRIEF DESCRIPTION OF THE DRAWINGS

FIG. 1 is a perspective view of the prior-art power winch.

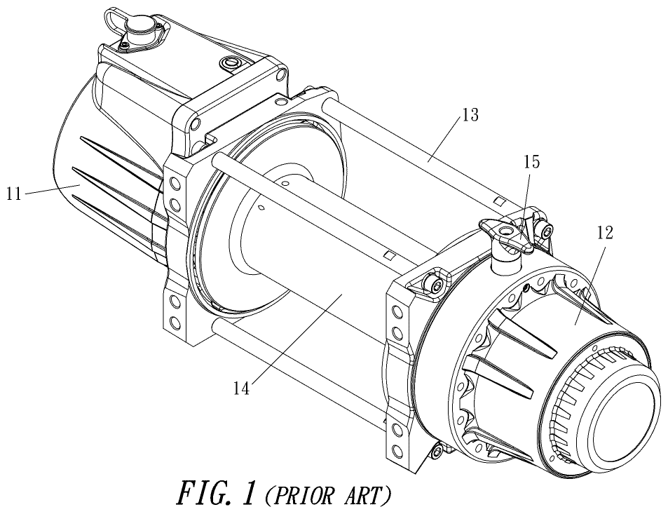

FIG. 2 is a perspective view of an embodiment of the present invention.

FIG. 3 is an exploded view of the primary part of an embodiment of the present invention.

FIG. 4 is a combined sectional view of the primary part of an embodiment of the present invention.

FIG. 5 is an exploded view of the characteristic part of an embodiment of the present invention.

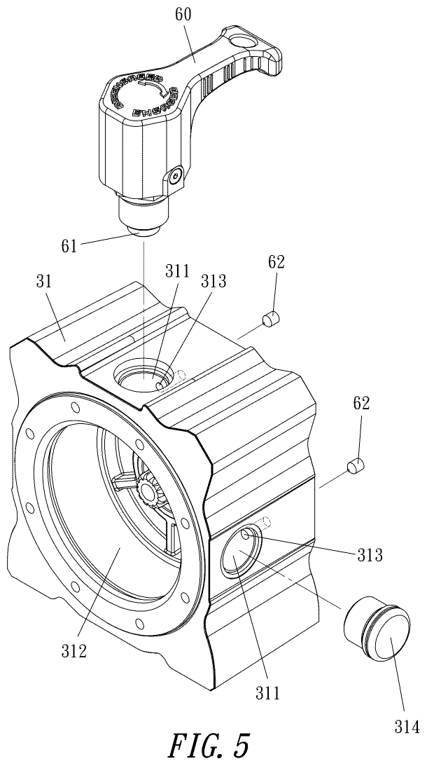

FIG. 6 is a perspective view of an embodiment of the present invention with the position of the clutch lever changed.

FIG. 7 is an exploded perspective view of an embodiment of the present invention with the position of the clutch lever changed.

### DETAILED DESCRIPTION OF EMBODIMENTS OF THE INVENTION

1 For better understanding of the technical means to achieve the above object and the effects of the present invention to be accomplished, detailed descriptions are provided below with respect to the following preferred embodiment and with reference to the accompanying figures.

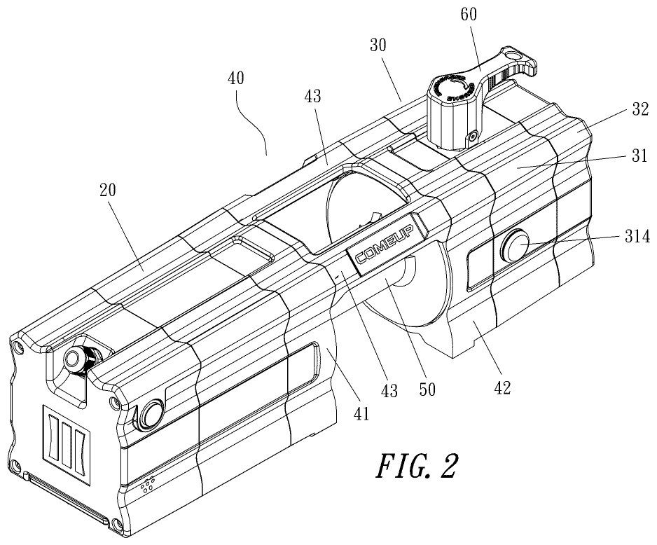

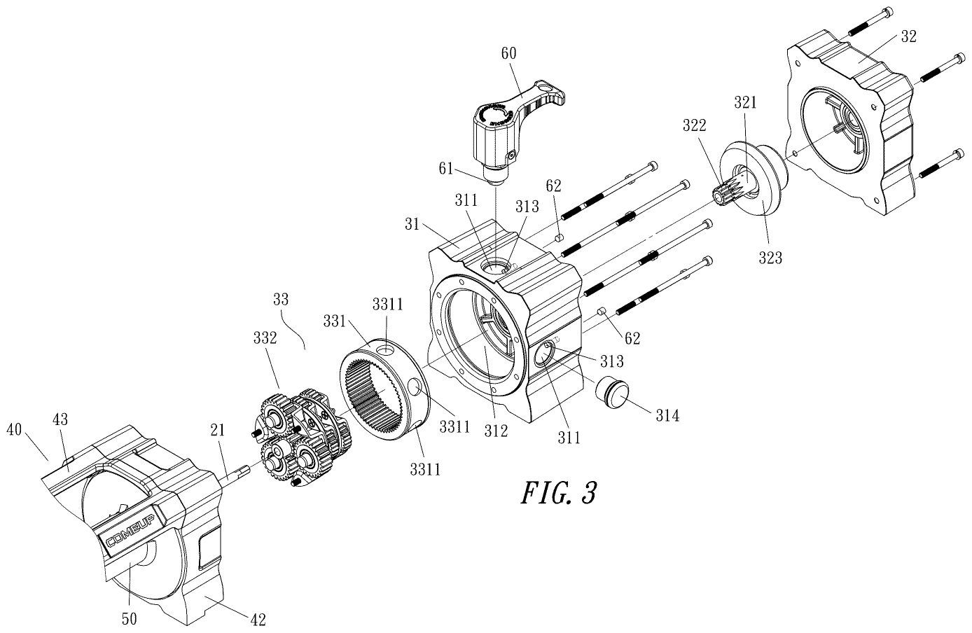

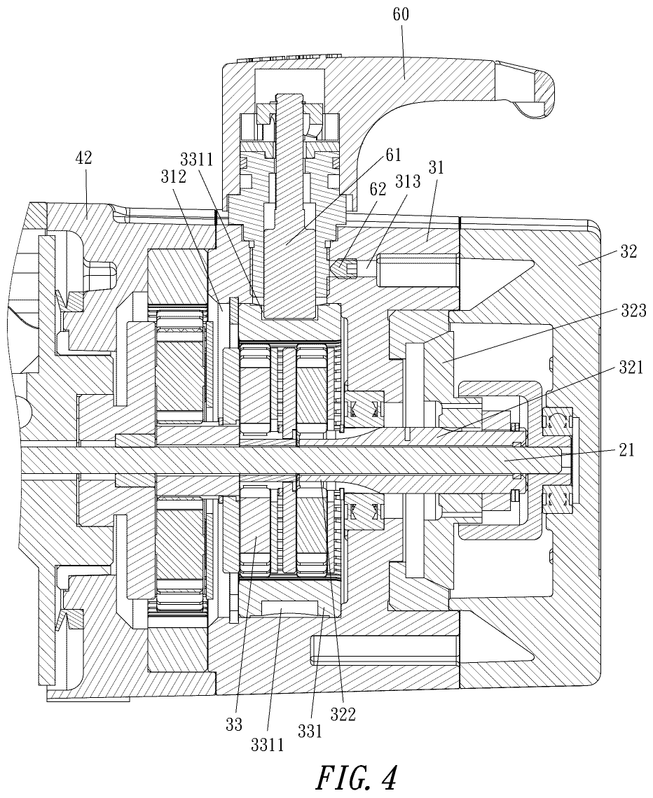

With reference to FIG. 2, the present invention is related to a power winch having an appearance structure of a power source 20 (such as a power motor) located on one side to output the forward or backward driving power and a speed reducer 30 is configured on the other side. The power source 20 and the speed reducer 30 are connected by a transmission shaft 21 (as shown in FIGS. 3 and 4) for power transmission, and meanwhile, the power source 20 and the speed reducer 30 are connected and supported by a support frame 40. The support frame 40 comprises a left frame 41, a right frame 42 and a frame plate 43. The left frame 41 is provided for lateral connection of the power source 20, the right frame 42 is provided for lateral connection of the speed reducer 30, and then the frame plate 43 is supported between the left frame 41 and the right frame 42, thereby defining an internal space. A cable wheel 50 is configured inside the internal space of the support frame 40, wherein a cable is winded on the cable wheel 50, no jointing or power connection are existed between the cable wheel 50 and the left frame 41 and right frame 42. The transmission shaft 21 passes through the cable wheel 50 without contact, and therefore the power supplied by the power source 20 is transmitted through the transmission shaft 21 to the speed reducer 30. After appropriate speed reduction, the power drives the cable wheel 50 to rotate (forward rotation or backward rotation), so as to release the rope or withdraw the rope.

With reference to FIGS. 3 and 4, the speed reducer 30 comprises a central housing 31, an outer housing 32, a speed reducing mechanism 33 and a clutch lever 60, wherein the central housing 31 and the outer housing 32 can be integrated into a housing. However, when dismantled, the housing is divided into a central housing 31 and an outer housing 32. The central housing 31 can be connected with the right frame 42. At least two positioning holes 311 are configured on the surface of the central housing 31, as shown in FIG. 3. One of the positioning holes 311 is located on the upper wall of the central housing 31, i.e., the positioning hole 311 faces upward. The other positioning hole 311 is located on the front wall of the central housing 31, i.e., the positioning hole 311 faces frontward. A round space 312 is configured inside the central housing 31 on the side facing the right frame 42. Longitudinal screw holes 313 are configured on the central housing 31 on the side away from the right frame 42, respectively in relation to the two positioning holes 311, and are communicated to the corresponding positioning holes 311. The positioning holes 311 can be optionally covered by a cover body 314. The speed reducing mechanism 33 is composed of an internal gear ring 331 and a planetary gear set 332. A plurality of positioning slots 3311 are configured on the outer wall of the internal gear ring 331. The internal gear ring 331 is held inside the round space 312 of the central housing 31. The planetary gear set 332 is a planetary gear set with multi-stage speed reduction, at least two-stage, and preferably three-stage. As depicted in FIG. 3, the planetary gear set 332 is a planetary gear set with three-stage speed reduction, wherein, the planetary gears of the first two stages (first and second stage) are made in the same size, and can be housed inside the internal gear ring 331 together, and be engaged with the teeth of the internal gear ring 331, the planetary gear of the last stage (third stage) is of a big size, and is positioned outside the central housing 31. Then, when the central housing 31 is connected with and assembled into the right frame 42, a corresponding internal gear ring is configured inside the right frame 42 for the planetary gear of the third stage to be housed and engaged. The planetary gear of the third stage and the corresponding internal gear ring are housed inside the neighboring right frame 42 to meet the requirement for reduced size. However, the planetary gear of the third stage and the corresponding internal gear ring are still a structural and functional part of the planetary gear set 332. The outer housing 32 is connected with the central housing 31. A bearing component is configured on the side of the outer housing 32 facing the central housing 31, with a shaft section 321 inserted in its center. The shaft section 321 is provided for insertion and connection by the transmission shaft 21 and is driven by the transmission shaft 21. Then, the tooth ring 322 of the shaft section 321 is engaged with first stage planetary gear of the planetary gear set 332 for power transmission. The shaft section 321 is connected with a brake disc 323. When needed, the brake disc 323 will contact the braking mechanism configured inside the central housing 31 to stop the motion. The clutch lever 60 is optionally inserted into either of the positioning holes 311 for positioning. The clutch lever 60 is a component of the clutch mechanism. Part of the structure of the clutch mechanism is fitted inside the central housing 31 of the speed reducer 30 and then extends upward. Seen from outside, only the clutch lever 60 is exposed. Other components are assembled and hidden inside the housing and beneath the clutch lever 60. The clutch lever 60 is configured with a pressing bar 61. The pressing bar 61 is controlled by the clutch lever 60 to rise or fall. When the pressing bar 61 falls, it goes into the corresponding positioning slot 3311 to abut against the internal gear ring 331, so that the internal gear ring 331 cannot rotate. On the contrary, when the pressing bar 61 rises, it leaves the positioning slot 3311, and the rotation of the internal gear ring 331 will not be affected. The clutch lever 60 includes a set of pressing blocks 62. The pressing block 62 has external threads and can be screwed into the corresponding screw hole 313 for movement.

According to the above-mentioned structure, the internal gear ring 331 is accommodated inside the round space 312 of the central housing 31 at the time of assembly, and then the planetary gears of the first two stages of the planetary gear set 332 is accommodated into the internal gear ring 331 to achieve the engagement with the teeth of the internal gear ring 331. Further, the central housing 31 is secured with the right frame 42, for example, a plurality of bolts are secured with the corresponding screw holes. At the time, the last-stage planetary gear of the planetary gear set 332 is entering the internal gear ring configured inside the right frame 42 to achieve the engagement. Then, the shaft section 321 and the brake disc 323 are assembled into the central housing 31 to enable the shaft section 321 to be inserted into the tip end of the transmission shaft 21 and fixed, and the tooth ring 322 of the shaft section 321 is engaged with the first stage planetary gear of the planetary gear set 332 to achieve the transmission. Further, the clutch lever 60 is optionally inserted into one of the positioning holes 311 to be positioned, and then, the pressing block 62 is entering and moving along the corresponding screw hole 313 till the front end of the pressing block 62 tightly abuts the clutch lever 60 to be inserted into the wall of the positioning hole 311. Finally, the outer housing 32 is closed toward the central housing 31 and secured with the central housing 31, for example, a plurality of bolts and corresponding screw holes.

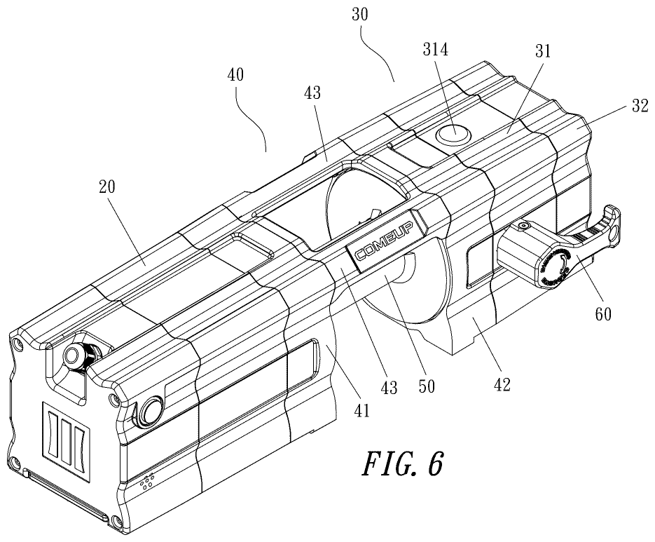

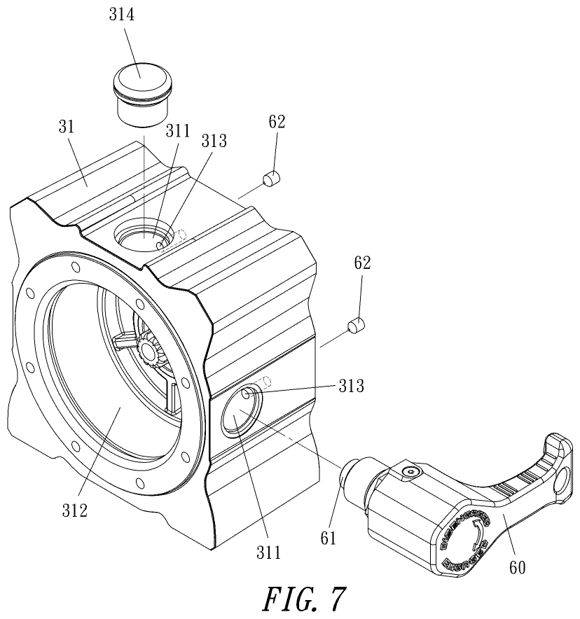

As mentioned above, at least two positioning penetrating holes 311 are configured on the surface of the central housing 31, wherein one of the positioning penetrating holes 311 faces upward and the other positioning hole 311 faces forward, and therefore, the clutch lever 60 can be optionally inserted and fixed in either of the positioning penetrating holes 311. As shown in FIG. 2~3 and 5, when the clutch lever 60 is inserted and fixed in the upward positioning penetrating hole 311, it is suitable for the power winch to be installed above the front end of the chassis or fixed on the front bumper, or installed and fixed above the rear end of the chassis or fixed on the rear bumper. In all these utilization modes, the clutch lever 60 is operated from above. Therefore, if the clutch lever 60 is inserted and positioned in the upward positioning penetrating hole 311, it is convenient to operate it. Now the forward positioning penetrating hole 311 is idle and can be covered by the cover body 314. Then, as shown in FIGS. 6 and 7, when the clutch lever 60 is inserted and positioned in the forward positioning penetrating hole 311, it is suitable for the power winch to be installed and fixed under the front end of the vehicle body or under the rear end of the vehicle body. As the power winch is installed downward, the clutch lever 60 can be changed to face frontward to facilitate operation. Now, as the upward positioning penetrating hole 311 is idle, it can also be covered by the cover body 314.

When the clutch lever 60 is originally inserted and fixed in one of the positioning holes 311, and it is needed to change the position and insert and fix it into the other positioning penetrating hole 311, the user can firstly release the fixation between the outer housing 32 and the central housing 31, for example, by screwing out the plurality of (four) bolts from the corresponding screw holes. Then, separate the outer housing 32 from the central housing 31, and withdraw the pressing block 62 which originally abuts the clutch lever 60 tightly. Then, pull the clutch lever 60 slowly out of the original positioning hole 311, and insert and fix it in the other positioning penetrating hole 311. Then, screw in the pressing block 62 to tightly abut against the clutch lever 60. Then, fix the outer housing 32 and the central housing 31 together again. Such an operation is very convenient. The clutch lever 60 can be separated and changed to the other position simply by releasing the four bolts between the outer housing 32 and the central housing 31 and removing the pressing blocks 62 at the two positions. During the process, there is no need to turn the central housing 31. After changing the position, just screw in the pressing blocks 62 and fix the outer housing 32 and the central housing 31 together again. Users who are not afraid of mechanical assembly and operation can easily change the position of the clutch lever 60 by themselves.

As described above, the main improvement of the present invention is that, at least two positioning holes are configured on the surface of the housing of the speed reducer of the power winch. One of the positioning holes is located on the upper wall of the housing of the speed reducer. The other positioning hole is located on the front wall of the housing of the speed reducer. The clutch lever of the power winch can be optionally inserted into either of the positioning holes to be positioned. As the clutch lever of the power winch can be conveniently inserted and positioned in either of the positioning holes, the power winch can have wider and diversified forms of installation and operation, thus realizing the object of the present invention. It is to be noted that, the clutch lever of the power winch can have many kinds of structural designs, including: transverse pushing type, T type, transverse pulling type, pneumatic type, electric type etc. As all of them are used for operating the speed reducer of the power winch to realize the clutch function, they all fall within the concept of “clutch lever” defined in the present invention. Therefore, any clutch lever of a power winch whose configuration position can be changed shall be covered by the scope of the present invention.

In summary, the present invention not only has novelty, but also has value for industrial utilization. Therefore, an application for invention patent is submitted. Your examination and approval will be highly appreciated.

What is claimed is:

1. A steering mechanism of a power winch clutch lever, the power winch comprising:
a support frame supporting a power source, a speed reducer and a cable wheel, and wherein,
the power source supplying a power and the power being transmitted to the cable wheel after speed reduction by the speed reducer, thereby enabling the cable wheel to rotate forward or backward;
the speed reducer comprising a housing, a speed reducing mechanism and a clutch lever, the housing connecting with the support frame, the positioning penetrating holes being configured on a surface of the housing, the speed reducing mechanism being composed of an internal gear ring and a planetary gear set, a plurality of positioning slots being configured on an outer wall of the internal gear ring, the internal gear ring being accommodated inside the housing, the planetary gear set being accommodated inside the internal gear ring to being engaged with the internal gear ring for the speed reduction, the clutch lever being inserted in the positioning penetrating holes of the housing, a pressing bar being configured inside the clutch lever, the pressing bar being controlled by the clutch lever to rise or fall, the pressing bar pressing into the positioning slot of the internal gear ring while falling, thereby enabling a power transmission of the speed reducer and the cable wheel being connected, the press bar withdrawing from the positioning slot of the internal gear ring while rising, thereby enabling the power transmission of the speed reducer and the cable wheel being interrupted, and wherein,
at least two positioning penetrating holes being configured on a surface of the housing, one of the positioning penetrating holes being configured on an upper wall of the housing, the other positioning penetrating hole being configured on the front wall of the housing, the clutch lever being able to be either inserted and positioned in the positioning penetrating hole on the upper wall of the housing or inserted and positioned in positioning penetrating hole on the front wall of the housing.

2. The steering mechanism of the power winch clutch lever of claim 1, wherein the housing comprising a central housing and an outer housing, the central housing being connected with the support frame, the outer housing being connected with the central housing, the positioning penetrating holes being configured on a surface of the central housing, a round space being configured inside a side of the central housing facing the support frame, and the internal gear ring being accommodated inside the round space of the central housing.

3. The steering mechanism of the power winch clutch lever of claim 2, wherein the longitudinal deep screw holes being respectively configured on a side of the central housing away from the support frame and corresponding to the two positioning penetrating holes, the screw holes communicating to the corresponding positioning penetrating holes, and the clutch lever comprising a pressing block entering along the corresponding screw hole to tightly abut against the clutch lever.

4. The steering mechanism of the power winch clutch lever of claim 2, wherein the positioning penetrating holes can be covered by a cover body.
